(19) United States
(12) Patent Application Publication
(10) Pub. No.: US 2004/0218963 A1
(43) Pub. Date: Nov. 4, 2004

(54) Customizable keyboard

(76) Inventors: Peter Jan Van Diepen, Vancouver (CA); Dana Sigrid Thordarson, Vancouver (CA)

Correspondence Address: PETER VAN DIEPEN, P3 - 1348 BARCLAY ST, VANCOUVER, BC, V6E 1H7, CA

(21) Appl. No.: 10/460,103

(22) Filed: Jun. 13, 2003

(30) Foreign Application Priority Data
Apr. 30, 2003 (CA) 2,426,867

(51) Int. Cl. G06F 3/023

(52) U.S. Cl. 400/472

(57) ABSTRACT

A customizable computer keyboard having a plurality of keys, of which each can be assigned any symbol or letter of any alphabet, or alphanumeric indicia in any sequence, not limited to standard QWERTY. Assignment of the symbols can be achieved by variety of methods, including replaceable keys, replaceable key tops, keys fitted with active display, or touch screen. Customization can be done by the user, as often as desired. Recognition of the custom pattern and symbols is achieved by employing a separate software, which enables the user to program custom symbols and fonts, to select them from a library thereof, or to select default patterns corresponding, for example, to foreign keyboard systems. This not only enhances flexibility of keyboard use and scope of its symbols in general, but also enables users of different background instantly convert to their keyboard patterns when using computers abroad, for example in internet cafes.

### U.S. Prior Application References

U.S. Pat. No. 4,948,232 August 1990 Lange

U.S. Pat. No. 5,626,429 May 1997 Choate

U.S. Pat. No. 5,668,358 September 1997 Wolf et al.

U.S. Pat. No. 5,893,133 April 1999 Chen

U.S. Pat. No. 5,920,303 July 1999 Baker et al.

U.S. Pat. No. 5,954,437 September 1999 Wen-Hung

U.S. Pat. No. 6,008,799 December 1999 Van Kleeck

U.S. Pat. No. 6,018,335 January 2000 Onley

U.S. Pat. No. 6,028,591 February 2000 Lueders

U.S. Pat. No. 6,053,647 April 2000 Parkinson

U.S. Pat. No. 6,281,884 August 2001 Chang, et al.

U.S. Pat. No. 6,281,886 August 2001 Ranieri

U.S. Pat. No. 6,326,953 December 2001 Wana

U.S. Pat. No. 6,359,572 March 2002 Vale

U.S. Pat. No. 6,437,709 August 2002 Hao

U.S. Pat. No. 6,462,678 October 2002 Ahn

U.S. Pat. No. 6,467,924 October 2002 Shipman

U.S. Pat. No. 6,467,979 October 2002 Camacho et al.

U.S. Pat. No. 6,480,587 November 2002 Rao et al.

### Foreign Prior Application References

Canadian Application # 2,426,867 filed on Apr. 30, 2003

### BACKGROUND OF THE INVENTION

This invention pertains generally to keyboards used as data entry devices for computers, personal computers and other equipment controlled by means of data entry by manual typing. More specifically, this invention relates to functionality of a keyboard. It represents an improvement to the presently available keyboard technology, by introducing flexibility in designing and/or assigning symbols to the specific keys.

The presently known keyboards, especially the computer keyboards, conform, in the vast majority of cases, to the QWERTY standard of the layout of English alphanumerical symbols, permanently displayed on the keys. While many users take it for granted that it is an optimum layout, it is widely recognized to have serious limitations. In his U.S. Pat. No. 5,626,429 Choate provides a very comprehensive historical perspective of the development of keyboards and their impact on efficiency of typing, and on the shortcomings of the QWERTY layout standard, particularly as the cause of numerous negative physical effects on the users' hands and arms. Without repeating the entire background, the following highlights the main problems this invention intends to address and overcome.

It is a well known fact that the standard QWERTY key layout was introduced in 1872, by C. Latham Sholes, in order to address the problem of jamming key levers of contemporary mechanical typewriters by increasingly fast typists. The QWERTY layout prevented jamming by distributing the most commonly used English characters in such a fashion that fast typists would jam their fingers thus slowing down their pace, before they would jam the key levers. Introduction of electric typewriters in 1930s solved this problem, and numerous patents soon followed for more efficient single- or two-handed keyboard layouts, e.g. U.S. Pat. No. 2,040,248 issued to A. Dvorak et al. They are discussed at depth in Choate U.S. Pat. No. 5,626,429, highlighting the fact that all these attempts to improve typing efficiency have failed, as too many people have already memorized Sholes' QWERTY keyboard, since referred to as “obsolete,” and were unwilling to adopt new layouts. This remains true to this day, and one should not expect all users to change their habits. However, this invention offers freedom to do so to those who are interested in learning a new layout, but presently cannot, bound by the will of the majority.

Quite apart from typing speed and efficiency, the impact of the QWERTY keyboard on the physical health of the users, chief among them Carpal Tunnel Syndrome (CTS), has been addressed in numerous proposals and patents. Again, all these proposed improvements have remained unimplemented for reasons stated above. This invention makes it possible to finally implement them.

Recently, another problem has emerged and is rapidly spreading with the advent of mass use of the Internet: the problems with using foreign keyboards. Using computers abroad has become the new reality of travel, either on pleasure or business. As computers and e-mail have become the main medium of communication, travelers are faced with the necessity of using unfamiliar keyboards while abroad. It is difficult enough for users of English keyboards to try using French or Spanish keyboards, where commonly used characters, such as commas or apostrophes, are found in a different location on the keyboard, or are replaced with characters specific to these languages, e.g. inverted question mark or accented vowels. Using keyboards in clients' offices or internet cafes in countries using similar alphabets is frustrating enough, but it is downright impossible to use keyboards in countries using their own alphabets, e.g. Cyrillic, Arabic or Hindi, to name just a few. This invention offers a solution to this growing problem.

### BRIEF SUMMARY OF THE INVENTION

It is a well known fact that the standard QWERTY key layout was introduced in 1872, by C. Latham Sholes, in order to address the problem of jamming key levers of contemporary mechanical typewriters by increasingly fast typists. The QWERTY layout prevented jamming by distributing the most commonly used English characters in such a fashion that fast typists would jam their fingers thus slowing down their pace, before they would jam the key levers. Introduction of electric typewriters in 1930s solved this problem, and numerous patents soon followed for more efficient single- or two-handed keyboard layouts, e.g. U.S. Pat. No. 2,040,248 issued to A. Dvorak et al. They are discussed at depth in Choate U.S. Pat. No. 5,626,429, highlighting the fact that all these attempts to improve typing efficiency have failed, as too many people have already memorized Sholes' QWERTY keyboard, since referred to as “obsolete,” and were unwilling to adopt new layouts. This remains true to this day, and one should not expect all users to change their habits. However, this invention offers freedom to do so to those who are interested in learning a new layout, but presently cannot, bound by the will of the majority.

Quite apart from typing speed and efficiency, the impact of the QWERTY keyboard on the physical health of the users, chief among them Carpal Tunnel Syndrome (CTS), has been addressed in numerous proposals and patents. Again, all these proposed improvements have remained unimplemented for reasons stated above. This invention makes it possible to finally implement them.

Recently, another problem has emerged and is rapidly spreading with the advent of mass use of the Internet: the problems with using foreign keyboards. Using computers abroad has become the new reality of travel, either on pleasure or business. As computers and e-mail have become the main medium of communication, travelers are faced with the necessity of using unfamiliar keyboards while abroad. It is difficult enough for users of English keyboards to try using French or Spanish keyboards, where commonly used characters, such as commas or apostrophes, are found in a different location on the keyboard, or are replaced with characters specific to these languages, e.g. inverted question mark or accented vowels. Using keyboards in clients' offices or internet cafes in countries using similar alphabets is frustrating enough, but it is downright impossible to use keyboards in countries using their own alphabets, e.g. Cyrillic, Arabic or Hindi, to name just a few. This invention offers a solution to this growing problem.

### BRIEF DESCRIPTION OF THE DRAWINGS

This invention does not require, nor it is illustrated by drawings.

### DETAILED DESCRIPTION OF THE INVENTION

The preferred embodiment of this invention is described in detail hereinafter, although it should be understood that this invention is not confined in any strict conformity with, or limited by the following description, but it may be modified to optimize its functionality, so long as one or several essential features claimed are present within the limits specified below and in the claims.

The first significant and unique feature not applied thus far to the design of a keyboard, is portability of the keys. Unlike the conventional keyboards, where characters are assigned to specific keys permanently, even including the keys which may have multiple functionality evoked by pressing Control (Ctrl), Function (Fn) or Alternative (Alt) keys simultaneously, and unlike the many keyboards which claim key layout superior to the conventional QWERTY standard, this invention describes a keyboard in which the layout of the characters can be changed by the user at will.

The second significant and unique feature not applied thus far to the design of a keyboard, is the ability to select, specify, or define any character, including user's own design thereof, not limited to the recognized alphanumeric characters, thus removing the limitation of the characters to those supplied with the keyboard.

The third significant and unique feature not applied thus far to the design of a keyboard, is the software which enables the computer to recognize the modified locations of the characters, or to select user defined types and layouts of characters, or to instantaneously select default international keyboard standards, for example English, Spanish, French, Arabic, Chinese, Hindi, etc.

The final significant and unique feature not applied thus far to the design of a keyboard, is the multitude of methods of presenting the characters on the keys, including mechanical, in form of interchangeable key tops, or electronic, in form of LCD display or similar.

Portability of the characters shown on the keys is the basis of this invention. To begin with, implementation of this invention would not impede at any time the ability to use such a keyboard by the majority of the users, who are expected to prefer using the conventional QWERTY standard. It will, however, enable those, who feel that a modified layout of characters will improve functionality of their computers or any other devices controlled by a keyboard, to do so. Those who feel that the QWERTY standard introduced by Sholes in 1872 to slow down the typing speed to prevent jamming of the key levers (which hasn't been an issue for over 80 years) unjustly limits their ability to type fast, can select any of the standards found to be more efficient, published or even patented but never implemented on a commercial scale because of the unwillingness of the majority of the users to change their habits. This invention will enable those who try using a computer in different countries, to do it quickly and efficiently and without the frustration of having to deal with an unfamiliar layout of the keys. Merely trying to use a French keyboard by a person accustomed to the English keyboard can be frustrating enough. Trying to use a keyboard with Arabic or Chinese or Hindi characters is downright impossible for the same person. This invention will enable foreign users to instantly select their own default standard even if the appearance of characters on the keys would not necessarily change, as most of computer users do not look down at the keyboard anyway, while typing. This invention will further enable the keyboard manufacturers to realize significant improvements in production processes and the associated cost savings, since it will enable to produce one keyboard in place of multiple keyboards with different character layouts. In the interim, it would introduce a new product to the already saturated market, while eventually it would enable manufacturers and users to reduce the overall volume of keyboard units, with obvious benefits to the environment.

Portability of the characters can be applied to any design and/or physical layout of the keyboard keys. Whether it is a standard rectangular 89 key laptop keyboard, or a full size 101 key unit, or an ergonomically shaped keyboard of any design, the proposed portability of the characters shown on the keys can be applied. This invention would also not prevent manufacturers from using their own specific keys, such as instant Internet access, “shopping” or similar. Several manufacturers' specific keys can always be retained as permanent in appearance and location.

The present invention will also free the user from the limitation of using the type of characters supplied with the keyboard. Alphanumeric characters are the most commonly used, but often additional characters are required, which are not found on a conventional keyboard. To provide them, software developers have introduced a multitude of libraries of characters and fonts. Access to them requires several steps. One example, in word processing software, is selecting the “Insert” pull-down menu with the cursor controlled by the mouse, then “symbol”, which opens a dialogue box with often multiple libraries of symbols, through which the user has to browse searching for the character he or she needs. Once found, it has to be selected and inserted into the body of the text the user has stopped typing, by pressing the “Insert” box. It is a multi-step and time-consuming operation. The present invention will enable users to store characters they need most often (for example currency symbols) in one location, for example in the seldom used top row of keys, occupied by the function keys (F1 through F12 in the standard QWERTY keyboard), or even in an additional “personal” row of keys, to access them more conveniently. Users in different professions require different symbols. While software developers strive to include them all in their libraries, it is a never-ending process, especially that industries continue developing new symbols. Symbols in long established fields, long before the advent of typing or computer technology, such as mathematics, physics, chemistry or even topography, have fortunately evolved into internationally recognized standards with only small variations between different countries or groups of users. However, in the many emerging fields different countries or groups of users, or even individual commercial firms or government agencies, use their own symbology, which not only is questioned by others, but also may be not recognized by others to begin with. This obviously prevents software developers from including the multitude of often conflicting symbols in standard libraries supplied to all buyers of the specific software, chiefly among it word processing. It should be kept in mind that this invention pertains primarily to the written (or more precisely: typed) text. Custom symbology is easier to deal with when it comes to drawings or graphics, where a symbol can be custom designed, saved and then inserted at will. But it is not available, at the time of this writing, in word processing software. This invention will enable users to design and store their own symbols, and then simply type them within the body of the text. They can even be shown on the keys, as it is described further herein.

This invention will enable users to switch instantly not only between either their own custom designed sets of characters and/or their layout, but also between default keyboards in different languages. To begin with, the differences in Latin alphabets used in most of Europe, Australia and the Americas, make it difficult, in some cases impossible, to communicate using a computer in a different country while traveling. Internet cafes occasionally provide separate stations for the English, French or Spanish users. However, most Latin languages have their own characters not found outside their countries of origin. Chief among them are the Scandinavian alphabets, with á, æ or ø, to point at just a few examples. These can be inserted from standard libraries, but inserting characters is not as efficient as simply typing them. Certain other European languages, such as Polish or Hungarian, have characters (for example “a” or a crossed L) that, at the time of this writing, do not even appear in the libraries of the commonly available word processing software. It is a common complaint in those countries that their own language cannot be properly typed. Specialized software begins to appear to plug these holes, but it is an ongoing process. This invention will enable every user to define every letter of his or her alphabet. Quite apart from that, users of every other alphabet: Cyrillic, Greek, Arabic, or many Asian alphabets rely on the keyboards custom designed for their countries' languages. Once in a different country, they cannot type in their own language to work with their documents or to communicate with families or places of work back home. This invention will remove these difficulties. Since most experienced users can type without looking at the keyboard, such a switch to a different language default can be made instantaneously without necessarily changing the appearance of the keyboard when it would be undesirable, for example at a host user's computer, or in an internet cafe. However, this invention does provide one of the many possible embodiments where such a change of appearance can be made at the same time, and it can be changed back to the previous standard once the guest user has finished his or her typing.

Which brings us to the last two aspects of this invention: the methods of presenting—and changing—the characters on the keyboard keys, and the methods of the computer system recognizing the new characters and/or their layout.

There are two main methods of presenting characters on keys that this invention proposes. The first one is by mechanical means, the second by electronic means.

In the first instance, appearance of the characters on the keys can be changed in several ways. The entire key can be designed to be released from the keyboard and moved to a new location. This can be accomplished with a snap pin attachment of a standard commercially available design, but while mentioned as a possible solution, it is not judged to be preferred. Since the standard keyboard construction includes a system of contacts with spring loaded pins (typically 3 mm vertical travel) on top of which the key top is attached, in order to assist the manufacturers to keep this method of construction and the associated tooling, the preferred mechanical method of changing key tops would be a split top construction. Again, several solutions are possible. One of them would be a top half of a key that detaches and attaches to the bottom half by a commercially common slide and snap action, or by a turn and snap action. Another method of detaching and attaching top halves of the keys can be by the means of a precisely fitting male and female metal plugs (it would be irrelevant which is male which is female), the bottom half one being a weak electromagnet. Such keyboard can be fitted with a switch, turning off the key magnet power when the user wishes to switch key location or replace some keys with others. In all these cases, the keyboard manufacturer can supply a great number of key tops, which show different characters, including blanks, on which the user can draw characters of his or her own design.

In the second instance, the keyboard keys would be fitted with a powered LCD or similar means of electronic display, complete with a rugged top, designed to withstand impact loads associated with typing. The strength aspect of the construction of such an LCD display is purely practical and as such, it is not subject of the claims of this invention. The characters would be displayed on the LCD key tops in contrasting colors. In fact, the choice of colors could again be that of the user: either the traditional white on gray, or the reverse, or even a standard color palette for the background and the character. With this method, the characters could even be multi-colored. This functionality could also provide illumination of the keys to work in the dark.

The methods of the system recognizing the new characters and their layout will be in the form of software, which can be either stand-alone, or be part of the operating system. The actual code is not subject to the claims in this patent application. Only its functionality is. It will be multifaceted and it is obvious that it must be the integral part of the new proposed functionality of a keyboard.

The basic recognition of the keystrokes is not proposed to be changed. But it is proposed that the new software offers three basic levels of functionality.

Firstly, the layout of the present keyboard would be replicated and displayed on the computer screen, as close to the actual physical layout proportions as practical (it is anticipated that some distortion could be allowed to accommodate typically horizontally elongated keyboard layout on a rectangular screen of different proportions). Any alternative layouts could be represented as well, e.g. split ergonomic keyboards. It is, in fact, anticipated that manufacturers of the specific keyboard models would include their graphic representation in the software stored on the accompanying CD.

Secondly, a “holding” area on the screen would be provided, where a character presently removed from the keyboard could be placed, along with a character from the location the former character would be meant to assume, by a drag-and-drop action, or any similar effective graphic technique. Once temporarily removed from their original key locations, the characters could be dragged and dropped to the new locations. To allow for an extreme case, the holding area should be either large enough, or flexible enough (e.g. initially smaller, but self-adjusting in size, either as a dialogue box, or a separate field on the computer screen, above or below the displayed representation of the keyboard being the obvious choice) to accommodate all the characters originally present on the given keyboard.

Changing by dragging and dropping could be accompanied by replicating the same operation physically, relocating and/or replacing keys or key tops, where a mechanical method is implemented. User would have to rely on his or her discipline to ensure the changes on the screen and on the keyboard correspond to each other precisely. Alternatively, key tops could be coded (fitted either with pins or a chip) in a manner that their position would be automatically detected by the keyboard and shown on the screen.

The functionality of accepting the changes could be provided either by means of pressing a button on the screen (“accept”, or “accept changes”—in the user's language—or a similar term), or pressing a physical “accept” button on the keyboard. At this point, the computer software would recognize the new layout, or the new set of characters, and display (and keep) them in the body of the typed text.

The embodiments of the invention in which an exclusive property or privilege is claimed are defined as follows:

1. A computer keyboard, in which alphanumeric or other characters shown on the individual keys can be reassigned to different keys by the user, or new characters defined and assigned to the specific keys, and be recognized by the computer operating system and applications.

2. A computer keyboard as defined in claim 1, wherein the keys are of a composite construction, of which the upper portion, on which the alphanumeric or other characters are permanently displayed, is detachable from the lower portion, and can be reattached and locked to the lower portion of a key by mechanical means of a standard commercial design.

3. A computer keyboard as defined in claim 1, wherein the keys are of a composite construction, of which the upper portion, on which the alphanumeric or other characters are permanently displayed, is detachable from the lower portion, the upper portion of a key fitted with a metal non-circular flat pin (male) or depression (female), the lower portion of a key fitted with a depression (female) or flat pin (male) matching the upper portion's fitting, and also fitted with an electromagnet, which is permanently powered while operating the keyboard, or deactivated to remove and replace the top portions of the keys.

4. A computer keyboard as defined in claim 1, wherein the keys are fitted with a liquid crystal display, or a similar powered display screen, on which alphanumeric or any other typed characters and/or symbols are displayed in the standard array of colors, said characters or symbols controlled by the software, which is either part of the operating system or a stand alone program.

5. A computer keyboard as defined in claim 1, wherein there is an additional set of keys dedicated to accept user's personal set of most often used characters not present in the initial standard set of characters supplied by the manufacturer.

6. A computer keyboard as defined in claim 1, wherein there are also keys with permanent functionality specific to the keyboard manufacturer, which cannot have other characters assigned, or their position changed.

7. A computer keyboard either separate or an integral part of a personal computer, where keys are not separate, but form a single flat touch-sensitive panel, on which the layout, size of keys and their number is designed by the user by means of a specialized software enabling such a design on the computer screen, and taking effect upon acceptance by the user, at which point the new keyboard is displayed on said touch screen.

8. A computer keyboard as defined in claim 7, wherein the touch-sensitive panel is not flat, but has keys permanently positioned and indicated either by a permanently outlined areas, or as raised portions of said touch-sensitive panel, the characters displayed on said keys.

9. A software, which provides interaction between the keyboard and the computer display and any application software that records alphanumeric or other typed characters, in a commercially ordinary manner, but it also displays the graphic representation of the keyboard on the computer screen and it enables user to move graphic representation of individual keys by a drag and drop action to a holding area outside the displayed image of the keyboard, living an empty outline of a key, and to move graphic representation of the keys from the holding area to a new location in an empty outline of a key on the displayed image of the keyboard.

10. A software as defined in claim 9, which has a box named “accept changes” or similar meaningful description, which, when depressed, causes the software to accept new alphanumeric or other typed characters as per key layout defined by the user, irrespective of whether the same layout has been replicated by the user on the physical keyboard or not.

11. A software as defined in claim 9, which has a library of predefined sets of alphanumeric and other typed characters corresponding to default computer keyboard standards for one or more countries other than USA, such as France, Spain and other European countries, as well as India, China, Russia, Arabic countries, and any other country of the world where a computer keyboard has a different set of characters, such default keyboard standard being selectable from said library by the user and taking effect upon depressing the box named “accept” in a given language, or a similar meaningful description or graphic symbol signifying acceptance of changes, irrespective of whether the same layout has been replicated by the user on the physical keyboard or not.

12. A software as defined in claim 9, which has an ability to import and assign to keyboard keys any character or graphic symbol defined in a commercially common format, such as bitmap or similar, and to store it in user's personal library of symbols that can be assigned to keyboard keys.

13. A software as defined in claim 9, which has the ability and tools allowing the user to define any character or graphic symbol, to assign it to keyboard keys and to store it in user's personal library of symbols that can be assigned to keyboard keys.

14. A computer keyboard as defined in claim 1, wherein there is an additional key marked “accept” in a given language, or a similar meaningful description or graphic symbol signifying acceptance of changes, said key, when depressed, prompting software defined in claim 9 to cause the changes in key layout to take effect.

15. A computer keyboard as defined in claim 1, wherein the location of the keys is automatically recognized by software defined in claim 9, by means of either physical coding, such as pins or depressions in the keys, said pins or depressions arranged in a pattern specific to given keys and recognized by sensors in the keyboard, or electronic coding in form of chips embedded in the keys, location of which is recognized by the sensors in the keyboard.
